(19) United States
(12) Patent Application Publication
(10) Pub. No.: US 2026/0115818 A1
(43) Pub. Date: Apr. 30, 2026

(54) GEAR GRINDER AND GEAR GRINDING METHOD

(71) Applicant: NIDEC MACHINE TOOL CORPORATION, Ritto (JP)

(72) Inventor: Yoshikoto YANASE, Ritto (JP)

(21) Appl. No.: 19/372,609

(22) Filed: Oct. 29, 2025

(30) Foreign Application Priority Data
Oct. 30, 2024 (JP) 2024-191091

(51) Int. Cl. B23F 1/02

(52) U.S. Cl. CPC B23F 1/023

(57) ABSTRACT

A gear grinder includes a workpiece rotator, a grinding wheel rotator, and a first mover. The workpiece rotator rotates a workpiece including teeth on an outer peripheral surface about a workpiece axis which is a central axis thereof. The grinding wheel rotator rotates a grinding wheel including threads on an outer peripheral surface about a grinding wheel axis which is a central axis thereof. The first mover moves the grinding wheel from one end to another end of the workpiece in the tooth width direction. The gear grinder grinds the workpiece, the workpiece including a first region located at a center portion in the tooth width direction and a second region closer to an end portion in the tooth width direction than the first region. The movement speed of the grinding wheel in the tooth width direction when grinding the first region is lower than in the second region.

### CROSS REFERENCE TO RELATED APPLICATION

The present application claims priority under 35 U.S.C. § 119 to Japanese Application No. 2024-191091, filed on Oct. 30, 2024, the entire contents of which are hereby incorporated herein by reference.

### 1. FIELD OF THE INVENTION

The present disclosure relates to gear grinders and gear grinding methods.

### 2. BACKGROUND

Conventionally, a gear grinder that grinds a workpiece serving as a gear is known. A gear grinder synchronously rotates a workpiece having teeth and a grinding wheel having threads, and brings the workpiece and the grinding wheel into contact with each other such that the groove of the grinding wheel meshes with the teeth of the workpiece. Then, by moving the contact point between the workpiece and the grinding wheel in the tooth width direction, the tooth of the workpiece is ground from one end to the other end in the tooth width direction.

A conventional gear grinder is described, for example, in JP 2016-083748 A.

### SUMMARY

Feed marks (tool marks) are generated on the surface of the tooth ground by the gear grinder. The feed marks are minute undulations formed on the surface of the tooth by the grinding wheel. The feed mark is periodically formed at a pitch corresponding to the movement speed of the grinding wheel. When the gears are meshed, noise may occur due to the feed mark. Specifically, in addition to noise having a frequency corresponding to the number of teeth of the gear, noise having a frequency corresponding to the pitch of the feed marks may occur.

Therefore, example embodiments of the present disclosure provide gear grinders and gear grinding methods each capable of reducing noise caused by feed marks.

A first example embodiment of the present disclosure provides a gear grinder to grind a workpiece serving as a gear, the gear grinder including a workpiece rotator to rotate a workpiece including a plurality of teeth on an outer peripheral surface about a workpiece axis that is a central axis of the workpiece, a grinding wheel rotator to rotate a grinding wheel including threads on an outer peripheral surface about a grinding wheel axis which is a central axis of the grinding wheel, and a first mover to move the grinding wheel from one end to the other end of the workpiece in a tooth width direction parallel or substantially parallel to the workpiece axis, in which the workpiece rotator and the grinding wheel rotator synchronously rotate the workpiece and the grinding wheel in a state where the workpiece and the grinding wheel mesh with each other, and the first mover is configured to move the grinding wheel to grind the workpiece, the workpiece includes a first region located at a center portion in the tooth width direction, and a second region closer to an end portion in the tooth width direction than the first region, and a movement speed of the grinding wheel in the tooth width direction when grinding the first region is lower than a movement speed of the grinding wheel in the tooth width direction when grinding the second region.

A second example embodiment of the present disclosure provides a gear grinding method of grinding a workpiece serving as a gear, the gear grinding method including grinding a workpiece by rotating a workpiece including a plurality of teeth on an outer peripheral surface thereof about a workpiece axis that is a central axis thereof, meshing a grinding wheel including threads on an outer peripheral surface thereof with the workpiece while rotating the grinding wheel about a grinding wheel axis which is a central axis thereof, and moving the grinding wheel from one end to another end of the workpiece in a tooth width direction parallel or substantially parallel to the workpiece axis, in which the workpiece includes a first region located at a center portion in the tooth width direction, and a second region closer to an end portion in the tooth width direction than the first region, and a movement speed of the grinding wheel in the tooth width direction when grinding the first region is lower than a movement speed of the grinding wheel in the tooth width direction when grinding the second region.

According to the first and second example embodiments, the pitch of the feed mark formed on the surface of the tooth by the grinding wheel can be made different between the first region and the second region. Accordingly, it is possible to reduce noise caused by the feed mark at the time of meshing the gear. In addition, noise perceived by a person can be reduced by increasing the frequency of noise generated from the first region that meshes relatively strongly.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram illustrating a configuration of a gear grinder according to an example embodiment of the present disclosure.

FIG. 2 is a flowchart illustrating a flow of an operation of the gear grinder.

FIG. 3 is a diagram illustrating a state of a workpiece and a grinding wheel in step S5.

FIG. 4 is a diagram illustrating a state of a workpiece and a grinding wheel in step S5.

FIG. 5 is a diagram illustrating a state of the workpiece and the grinding wheel in step S5.

FIG. 6 is a graph illustrating a change in a movement speed of a grinding wheel according to an example embodiment of the present disclosure.

FIG. 7 is a graph illustrating a noise analysis result when a workpiece is ground while a grinding wheel is moved at a constant movement speed.

FIG. 8 is a graph illustrating a noise analysis result when a workpiece is ground while a movement speed of a grinding wheel is changed.

### DETAILED DESCRIPTION OF THE EXAMPLE EMBODIMENTS

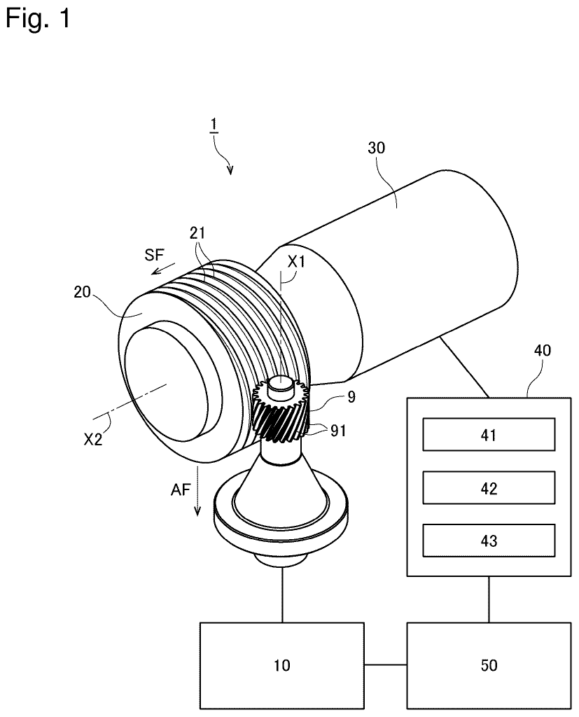

FIG. 1 is a diagram illustrating a configuration of a gear grinder 1 according to an example embodiment. The gear grinder 1 is a machine tool that grinds a workpiece 9 serving as a gear.

The workpiece 9 has a substantially cylindrical shape, and has a plurality of teeth 91 on an outer peripheral surface thereof. Hereinafter, the central axis of the workpiece 9 is referred to as a “workpiece axis X1”. A direction parallel or substantially parallel to the workpiece axis X1 is referred to as a “tooth width direction”. The gear manufactured by grinding the workpiece 9 is, for example, a helical gear. The workpiece 9 serving as a helical gear has the spiral teeth 91 centered on the workpiece axis X1. However, the gear manufactured by grinding the workpiece 9 may be another gear such as a spur gear.

As illustrated in FIG. 1, the gear grinder 1 includes a workpiece rotator 10, a grinding wheel 20, a grinding wheel rotator 30, a mover 40, and a controller 50. The workpiece rotator 10, the grinding wheel rotator 30, and the mover 40 are installed on a common bed (not illustrated).

The workpiece rotator 10 is a mechanism that rotates the workpiece 9 about the workpiece axis X1. The workpiece rotator 10 includes a pair of clampers that hold the workpiece 9 and a motor that rotates the clampers. In the present example embodiment, the workpiece 9 rotates while being held in a posture in which the workpiece axis X1 faces the vertical direction. However, the direction of the workpiece axis X1 is not necessarily the vertical direction.

The grinding wheel 20 is a tool for grinding the teeth 91 of the workpiece 9. The grinding wheel 20 has a substantially cylindrical shape, and has threads 21 on an outer peripheral surface thereof. Hereinafter, the central axis of the grinding wheel 20 is referred to as a “grinding wheel axis X2”. A direction parallel or substantially parallel to the grinding wheel axis X2 is referred to as a “shift direction”.

The grinding wheel rotator 30 is a mechanism that rotates the grinding wheel 20 about the grinding wheel axis X2. The grinding wheel rotator 30 includes a tool head that holds the grinding wheel 20 and a motor that rotates the tool head. In the present example embodiment, the grinding wheel 20 rotates while being held in a posture in which the grinding wheel axis X2 is disposed horizontally.

The mover 40 is a mechanism that moves the grinding wheel 20 with respect to the workpiece 9. The mover 40 moves the entire grinding wheel 20 and the grinding wheel rotator 30. The mover 40 includes a first mover 41, a second mover 42, and a third mover 43. The first mover 41 moves the grinding wheel 20 from one end to the other end of the workpiece 9 in the tooth width direction. The second mover 42 moves the grinding wheel 20 in the shift direction with respect to the workpiece 9. The third mover 43 moves the grinding wheel 20 toward and away from the workpiece 9.

The first mover 41, the second mover 42, and the third mover 43 are realized by, for example, a motor and a ball screw that converts rotation of the motor into linear motion. By the first mover 41, the second mover 42, and the third mover 43, the mover 40 can move the grinding wheel 20 in an arbitrary direction in the three-dimensional space with respect to the workpiece 9.

The mover 40 may include a fourth mover that adjusts a swivel angle of the grinding wheel axis X2 with respect to the workpiece axis X1.

The controller 50 is configured or programmed to control the operation of each portion of the gear grinder 1. The controller 50 may include, for example, a computer having a processor such as a CPU, a memory such as a RAM, and a storage unit such as a hard disk. The storage unit stores a computer program executable to control the operation of the gear grinder 1.

In addition, the controller 50 is communicably connected to the workpiece rotator 10, the grinding wheel rotator 30, and the mover 40 described above. The controller 50 is configured or programmed to control the operation of these units in accordance with the computer program described above. As a result, the grinding processing of the workpiece 9 in the gear grinder proceeds.

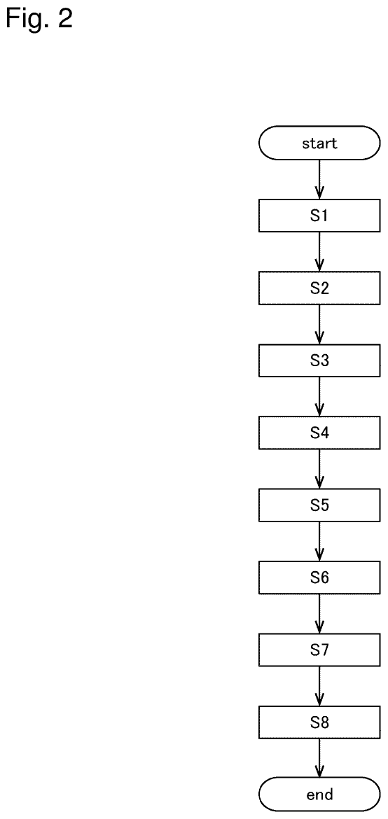

Next, a method of grinding the workpiece 9 to be a gear by the gear grinder 1 will be described. FIG. 2 is a flowchart illustrating a flow of an operation of the gear grinder 1.

When grinding the workpiece 9, first, the user inputs machining conditions to the controller 50 (step S1). The user inputs machining conditions to the controller 50 via an input device such as a keyboard or a mouse. The machining conditions include, for example, conditions related to the rotation speed of the workpiece 9, the rotation speed of the grinding wheel 20, and the movement of the grinding wheel 20 by the first mover 41. However, the machining condition may include other conditions.

Next, the workpiece 9 is set in the gear grinder 1 (step S2). The workpiece 9 is held by a pair of clampers of the workpiece rotator 10. Thereafter, the workpiece rotator 10 starts the rotation of the workpiece 9 about the workpiece axis X1 (step S3). In addition, the grinding wheel rotator 30 starts the rotation of the grinding wheel 20 about the grinding wheel axis X2 (step S4). When the plurality of workpieces 9 are continuously ground, the rotation of the grinding wheel 20 is not stopped for each workpiece 9. In this case, when grinding the second and subsequent workpieces 9, the already rotating grinding wheel 20 is continuously rotated in step S4.

The controller 50 is configured or programmed to control the workpiece rotator 10 and the grinding wheel rotator 30 so that the workpiece 9 and the grinding wheel 20 rotate synchronously. The synchronous rotation means that the workpiece 9 and the grinding wheel 20 rotate in a phase capable of meshing with each other. The controller 50 causes the workpiece 9 and the grinding wheel 20 to rotate synchronously by the workpiece rotator 10 and the grinding wheel rotator 30 in a state where the workpiece 9 and the grinding wheel 20 mesh with each other by bringing the grinding wheel 20 close to the workpiece 9. Then, the controller 50 moves the grinding wheel 20 with respect to the workpiece 9 by the first mover 41 (step S5).

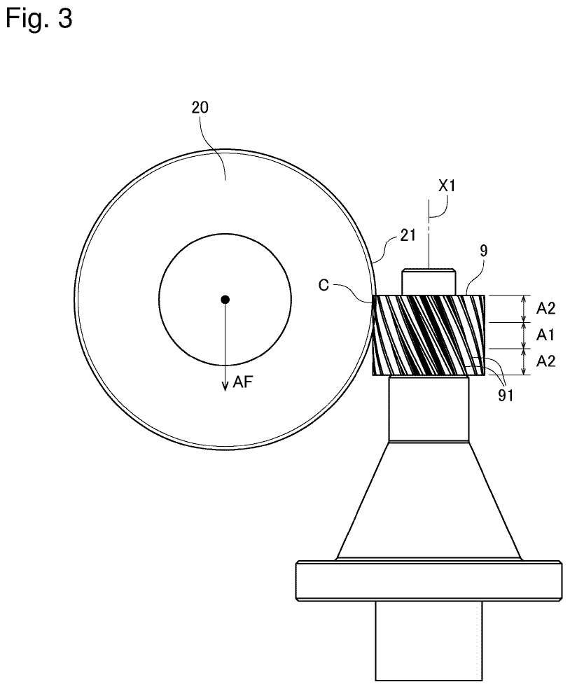

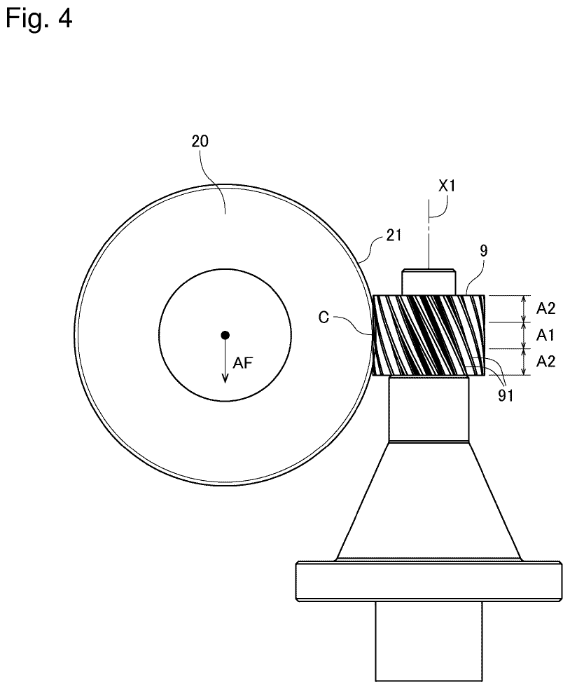

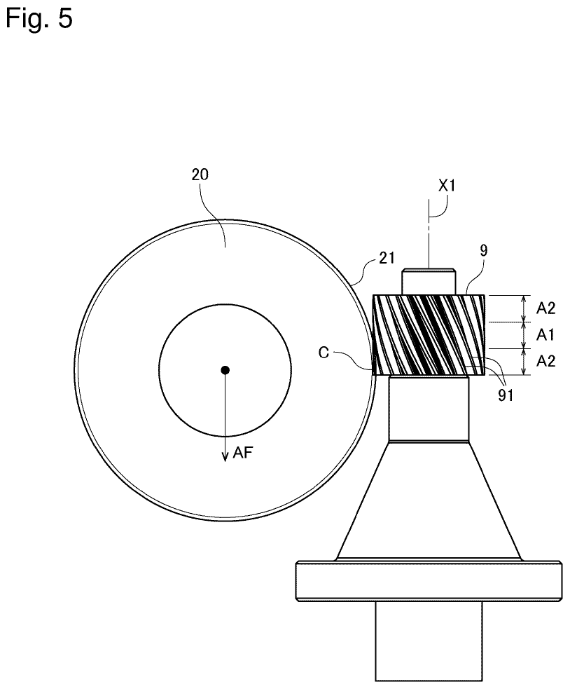

FIGS. 3, 4, and 5 are diagrams illustrating states of the workpiece 9 and the grinding wheel 20 in step S5. As illustrated in FIGS. 3, 4, and 5, the mover 40 moves the grinding wheel 20 from one end to the other end of the workpiece 9 in the tooth width direction. More specifically, the mover 40 moves the grinding wheel 20 such that a contact point C between the workpiece 9 and the grinding wheel 20 moves from one end to the other end of the workpiece 9 in the tooth width direction. At this time, the moving direction of the grinding wheel 20 may be the tooth width direction, or may be a direction slightly inclined with respect to the tooth width direction. That is, the moving direction of the grinding wheel 20 may be a direction including a component in the tooth width direction.

At the contact point C between the workpiece 9 and the grinding wheel 20, the teeth 91 of the workpiece 9 and the groove 21 of the grinding wheel 20 come into sliding contact with each other at a sliding speed corresponding to the rotation speed. As a result, the surface of the teeth 91 of the workpiece 9 is ground. As the contact point C moves in the tooth width direction, the teeth 91 of the workpiece 9 are ground from one end to the other end in the tooth width direction.

At this time, a feed mark (tool mark) is formed on the surface of the teeth 91 of the workpiece 9. The feed mark is minute undulations formed on the surface of the teeth 91 by the grinding wheel 20. The feed mark is periodically formed at a pitch corresponding to the movement speed AF of the grinding wheel 20. In a case where the pitch of the feed mark is constant, noise having a frequency corresponding to the pitch of the feed mark occurs at the time of meshing of the gear. Therefore, the first mover 41 changes the movement speed AF of the grinding wheel 20 while moving the grinding wheel 20 from one end to the other end of the workpiece 9. As a result, the pitch of the feed mark generated in the teeth 91 of the workpiece 9 is changed.

As illustrated in FIGS. 3, 4, and 5, the workpiece 9 has a first region A1 and a pair of second regions A2. The first region A1 is a region located at the center of the workpiece 9 in the tooth width direction. The second region A2 is a region closer to the end portion of the workpiece 9 in the tooth width direction than the first region A1. One of the pair of the second regions A2 is located between the first region A1 and one end of the workpiece 9 in the tooth width direction. The other one of the pair of second regions A2 is located between the first region A1 and the other end of the workpiece 9 in the tooth width direction.

The first mover 41 makes the movement speed AF of the grinding wheel 20 in the tooth width direction when grinding the first region A1 slower than the movement speed AF of the grinding wheel 20 in the tooth width direction when grinding the second region A2. In this way, the pitch of the feed mark formed on the surface of the teeth 91 by the grinding wheel 20 can be made different between the first region A1 and the second region A2. As a result, the frequency of the noise generated when the gears mesh with each other can be made different between the first region A1 and the second region A2. Therefore, it is possible to suppress an increase in noise of the gear at a specific frequency. As a result, noise caused by the feed mark can be reduced.

When the gears mesh with each other, the gears mesh more strongly in the first region A1, which is the central portion in the tooth width direction, than in the second region A2. Therefore, the noise generated from the first region A1 tends to be larger than the noise generated from the second region A2. Therefore, in the present example embodiment, the movement speed AF of the grinding wheel 20 when grinding the first region A1 is made smaller than the movement speed AF of the grinding wheel 20 when grinding the second region A2. In this way, the pitch of the feed marks generated in the first region A1 is smaller than the pitch of the feed marks generated in the second region A2. The height of the feed mark generated in the first region A1 is lower than the height of the feed mark generated in the second region A2. As a result, the frequency of relatively large noise generated from the first region A1 increases. As a result, noise perceived by a person can be reduced.

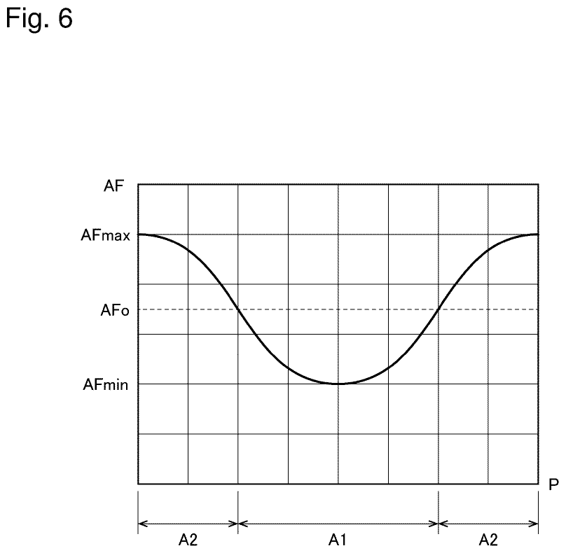

FIG. 6 is a graph illustrating a change in the movement speed AF of the grinding wheel 20. The horizontal axis in FIG. 6 indicates the position P of the contact point C in the tooth width direction. The vertical axis in FIG. 6 indicates the movement speed AF of the grinding wheel 20 in the tooth width direction. In the present example embodiment, the first mover 41 gradually changes the movement speed AF of the grinding wheel 20 in the tooth width direction between the first region A1 and the second region A2. That is, the first mover 41 continuously changes the movement speed of the grinding wheel 20 instead of stepwise. As a result, it is possible to smoothly change the pitch of the feed mark generated on the teeth 91 of the workpiece 9.

In particular, in the example of FIG. 6, the first mover 41 changes the movement speed AF of the grinding wheel 20 in the tooth width direction in a sinusoidal shape. In this way, the feed marks can be formed at equal pitches in the two second regions A2. In addition, the pitch change rate of the feed mark can be smoothly changed. Therefore, noise at the time of gear meshing can be further reduced.

The controller 50 calculates how to change the movement speed AF of the grinding wheel 20 based on the machining condition input by the user to the controller 50 in step S1. For example, the user inputs a reference value AFo of the movement speed AF and a change rate h of the movement speed AF to the controller 50. Then, the controller 50 calculates a maximum value AFmax and a minimum value AFmin of the movement speed AF according to the following calculation Expressions (1) and (2), for example.

AFmax=AFo×(1+h) (1)

AFmin=AFo×(1−h) (2)

The change rate h is, for example, a value larger than 0 and 0.9 or less. In this case, the maximum value AFmax of the movement speed AF of the grinding wheel 20 in the tooth width direction is larger than 1 time and 20 times or less the minimum value AFmin of the movement speed AF of the grinding wheel 20 in the tooth width direction. Accordingly, it is possible to more appropriately reduce the noise caused by the feed mark at the time of meshing the gear.

The maximum value AFmax of the movement speed AF of the grinding wheel 20 in the tooth width direction is more desirably 1.5 times or more and 10 times or less the minimum value AFmin of the movement speed AF of the grinding wheel 20 in the tooth width direction. Further, the maximum value AFmax of the movement speed AF of the grinding wheel 20 in the tooth width direction is more desirably 2 times or more and 5 times or less the minimum value AFmin of the movement speed AF of the grinding wheel 20 in the tooth width direction. Accordingly, it is possible to more appropriately reduce the noise caused by the feed mark at the time of meshing the gear.

In the present example embodiment, while the grinding wheel 20 moves once from one end to the other end of the workpiece 9 in the tooth width direction, the movement speed AF of the grinding wheel 20 in the tooth width direction becomes the minimum value AFmin only once. In this way, the load applied to the first mover 41 can be reduced as compared with a case where the movement speed AF of the grinding wheel 20 in the tooth width direction repeatedly increases and decreases.

In step S1, instead of the reference value AFo, the user may input a movement time T of the contact point C from one end to the other end of the workpiece 9 to the controller 50. That is, in step S1, the user may input the movement time T and the change rate h to the controller 50. In this case, the controller 50 calculates the movement speed AF of the grinding wheel 20 in the tooth width direction based on the input change rate h and the movement time T. Specifically, the controller 50 calculates the movement speed AF such that the time required to move the contact point C from one end to the other end of the workpiece 9 while changing the movement speed AF based on the input change rate h becomes the input movement time T. In this way, the workpiece 9 can be ground while changing the movement speed AF of the grinding wheel 20 and keeping the designated movement time T.

In step S5, the grinding wheel 20 may be moved in the shift direction by the second mover 42 while the grinding wheel 20 is moved in the tooth width direction by the first mover 41. In this way, the portion of the grinding wheel 20 in contact with the workpiece 9 can be dispersed. As a result, the life of the grinding wheel 20 can be extended. However, it is desirable that the movement speed SF of the grinding wheel 20 in the shift direction by the second mover 42 is sufficiently smaller than the movement speed AF of the grinding wheel 20 in the tooth width direction by the first mover 41.

The movement speed AF of the grinding wheel 20 in the tooth width direction by the first mover 41 is changed as described above, but the movement speed SF of the grinding wheel 20 in the shift direction by the second mover 42 does not need to be changed in accordance with the movement speed AF in the tooth width direction. Rather, the load on the second mover 42 can be reduced when the movement speed SF of the grinding wheel 20 in the shift direction is constant.

After the grinding wheel 20 is moved from one end to the other end of the workpiece 9 in the tooth width direction, the mover 40 separates the grinding wheel 20 from the workpiece 9. Then, the grinding wheel rotator 30 stops the rotation of the grinding wheel 20 (step S6), and the workpiece rotator 10 stops the rotation of the workpiece 9 (step S7). Thereafter, the workpiece 9 is taken out from the gear grinder 1 (step S8). When the workpiece 9 is automatically replaced by the loader and the next workpiece 9 is continuously ground, the above-described step S7 may be omitted and the rotation of the grinding wheel 20 may be continued.

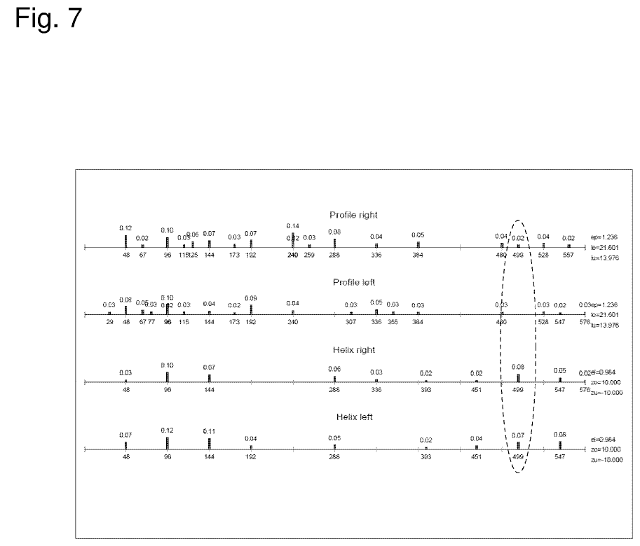

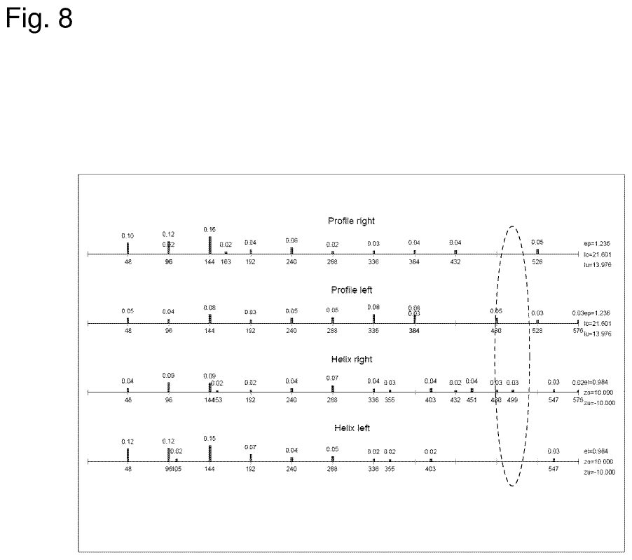

FIG. 7 is a graph (comparative example) illustrating a result of order analysis of minute undulations formed on a tooth surface of a gear manufactured by grinding the workpiece 9 while moving the grinding wheel 20 at a constant movement speed AF and measuring the shape of the tooth surface of the obtained gear. FIG. 8 is a graph (example) illustrating a result of order analysis of minute undulations formed on a tooth surface by producing a gear by grinding the workpiece 9 while changing the movement speed AF of the grinding wheel 20 as in FIG. 6 and measuring the shape of the tooth surface of the obtained gear. In the experiments of FIGS. 7 and 8, the conditions other than the movement speed AF of the grinding wheel 20 are the same.

The horizontal axis of the graphs of FIGS. 7 and 8 indicates the order of the undulation of the tooth surface. The vertical axis of the graphs of FIGS. 7 and 8 indicates the magnitude of the undulation of the tooth surface. The order and magnitude of these undulations have a high correlation with the magnitude of noise when the gears are actually meshed.

In the experiments of FIGS. 7 and 8, a gear having 48 teeth has been used. Therefore, it is considered normal that minute undulation having an order of an integral multiple of 48 is generated on the tooth surface. However, in the example of FIG. 7, as in a portion surrounded by a broken line, the undulation having an order of 499 that is not an integral multiple of 48 is generated on the tooth surface. The undulation of the order of 499 is considered to be caused by the feed mark caused by the movement speed AF of the grinding wheel 20. On the other hand, in the example of FIG. 8, the undulation having the order of 499 is hardly generated. From this result, as illustrated in FIG. 8, it has been confirmed that the undulation having the order that is not an integral multiple of the number of teeth can be reduced by changing the movement speed AF of the grinding wheel 20. Therefore, it can be seen that noise at the time of gear meshing can also be reduced by changing the movement speed AF of the grinding wheel 20.

While the example embodiments of the present disclosure have been described above, the present disclosure is not limited to the example embodiments described above.

In the above example embodiments, in step S5, the grinding wheel 20 moves from the upper end to the lower end of the workpiece 9. However, in step S5, the grinding wheel 20 may be moved from the lower end toward the upper end of the workpiece 9.

In the above example embodiments, the movement speed AF of the grinding wheel 20 in the tooth width direction is changed in a sinusoidal shape. However, the movement speed AF of the grinding wheel 20 in the tooth width direction may be changed in another manner such as a quadratic curve or a step shape.

In the above example embodiments, while the grinding wheel 20 moves once from one end to the other end of the workpiece 9 in the tooth width direction, the movement speed AF of the grinding wheel 20 in the tooth width direction becomes the minimum value AFmin only once. However, the movement speed AF of the grinding wheel 20 in the tooth width direction may become the minimum value AFmin a plurality of times while the grinding wheel 20 moves once from one end to the other end of the workpiece 9 in the tooth width direction.

Also note that features of the above-described example embodiments and the modifications thereof may be combined appropriately as long as no conflict arises.

The present technology can have the following configurations.
(1) A gear grinder to grind a workpiece serving as a gear, the gear grinder including a workpiece rotator to rotate a workpiece including a plurality of teeth on an outer peripheral surface about a workpiece axis that is a central axis of the workpiece, a grinding wheel rotator to rotate a grinding wheel including threads on an outer peripheral surface about a grinding wheel axis which is a central axis of the grinding wheel, and a first mover to move the grinding wheel from one end to the other end of the workpiece in a tooth width direction parallel or substantially parallel to the workpiece axis, in which the workpiece rotator and the grinding wheel rotator synchronously rotate the workpiece and the grinding wheel in a state where the workpiece and the grinding wheel mesh with each other, and the first mover moves the grinding wheel to grind the workpiece, the workpiece includes a first region located at a center portion in the tooth width direction, and a second region closer to an end portion in the tooth width direction than the first region, and a movement speed of the grinding wheel in the tooth width direction when grinding the first region is lower than a movement speed of the grinding wheel in the tooth width direction when grinding the second region.
(2) The gear grinder according to (1), in which the first mover gradually changes a movement speed of the grinding wheel in the tooth width direction between the first region and the second region.
(3) The gear grinder according to (2), in which the first mover changes a movement speed of the grinding wheel in the tooth width direction in a sinusoidal shape.
(4) The gear grinder according to any one of (1) to (3), in which a maximum value of a movement speed of the grinding wheel in the tooth width direction is more than 1 time and 20 times or less a minimum value of a movement speed of the grinding wheel in the tooth width direction.
(5) The gear grinder according to (4), in which the movement speed of the grinding wheel in the tooth width direction becomes the minimum value only once while the first mover moves the grinding wheel once from one end to another end of the workpiece in the tooth width direction.
(6) The gear grinder according to any one of (1) to (5), further including a controller configured or programmed to calculate a movement speed of the grinding wheel in the tooth width direction based on a change rate of a movement speed of the grinding wheel in the tooth width direction and a movement time of the grinding wheel in the tooth width direction.
(7) The gear grinder according to any one of (1) to (6), further including a second mover to move the grinding wheel with respect to the workpiece in a shift direction parallel or substantially parallel to the grinding wheel axis, in which the grinding wheel is moved at a constant speed in the shift direction by the second mover while moving the grinding wheel in the tooth width direction by the first mover.
(8) A gear grinding method of grinding a workpiece serving as a gear, the gear grinding method including a step of grinding a workpiece by rotating a workpiece including a plurality of teeth on an outer peripheral surface thereof about a workpiece axis that is a central axis thereof, meshing a grinding wheel having threads on an outer peripheral surface thereof with the workpiece while rotating the grinding wheel about a grinding wheel axis which is a central axis thereof, and moving the grinding wheel from one end to another end of the workpiece in a tooth width direction parallel or substantially parallel to the workpiece axis, in which the workpiece includes a first region located at a center portion in the tooth width direction, and a second region closer to an end portion in the tooth width direction than the first region, and a movement speed of the grinding wheel in the tooth width direction when grinding the first region is lower than a movement speed of the grinding wheel in the tooth width direction when grinding the second region.
(9) The gear grinding method according to (8), in which a movement speed of the grinding wheel in the tooth width direction is gradually changed between the first region and the second region.
(10) The gear grinding method according to (9), in which a movement speed of the grinding wheel in the tooth width direction is changed in a sinusoidal shape.
(11) The gear grinding method according to any one of (8) to (10), in which a maximum value of a movement speed of the grinding wheel in the tooth width direction is more than 1 time and 20 times or less a minimum value of a movement speed of the grinding wheel in the tooth width direction.
(12) The gear grinding method according to (11), in which a movement speed of the grinding wheel in the tooth width direction becomes the minimum value only once while the grinding wheel moves once from one end to the other end of the workpiece in the tooth width direction.
(13) The gear grinding method according to any one of (8) to (12), in which a movement speed of the grinding wheel in the tooth width direction is calculated based on a change rate of a movement speed of the grinding wheel in the tooth width direction and a movement time of the grinding wheel in the tooth width direction.
(14) The gear grinding method according to any one of (8) to (13), in which, in the step, the grinding wheel is moved at a constant speed in a shift direction parallel or substantially parallel to the grinding wheel axis while the grinding wheel is moved in the tooth width direction.

Example embodiments of the present disclosure provide gear grinders and gear grinding methods.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A gear grinder to grind a workpiece serving as a gear, the gear grinder comprising:
a workpiece rotator to rotate a workpiece including a plurality of teeth on an outer peripheral surface about a workpiece axis that is a central axis of the workpiece;
a grinding wheel rotator to rotate a grinding wheel including threads on an outer peripheral surface about a grinding wheel axis which is a central axis of the grinding wheel; and
a first mover to move the grinding wheel from one end to another end of the workpiece in a tooth width direction parallel or substantially parallel to the workpiece axis; wherein
the workpiece rotator and the grinding wheel rotator synchronously rotate the workpiece and the grinding wheel in a state where the workpiece and the grinding wheel mesh with each other, and the first mover moves the grinding wheel to grind the workpiece;
the workpiece includes:
a first region located at a center portion in the tooth width direction; and
a second region closer to an end portion in the tooth width direction than the first region; and
a movement speed of the grinding wheel in the tooth width direction when grinding the first region is lower than a movement speed of the grinding wheel in the tooth width direction when grinding the second region.

2. The gear grinder according to claim 1, wherein the first mover gradually changes a movement speed of the grinding wheel in the tooth width direction between the first region and the second region.

3. The gear grinder according to claim 2, wherein the first mover changes a movement speed of the grinding wheel in the tooth width direction in a sinusoidal shape.

4. The gear grinder according to claim 1, wherein a maximum value of a movement speed of the grinding wheel in the tooth width direction is more than 1 time and 20 times or less a minimum value of a movement speed of the grinding wheel in the tooth width direction.

5. The gear grinder according to claim 4, wherein the movement speed of the grinding wheel in the tooth width direction becomes the minimum value only once while the first mover moves the grinding wheel once from one end to another end of the workpiece in the tooth width direction.

6. The gear grinder according to claim 1, further comprising a controller configured or programmed to calculate a movement speed of the grinding wheel in the tooth width direction based on a change rate of a movement speed of the grinding wheel in the tooth width direction and a movement time of the grinding wheel in the tooth width direction.

7. The gear grinder according to claim 1, further comprising a second mover to move the grinding wheel with respect to the workpiece in a shift direction parallel or substantially parallel to the grinding wheel axis; wherein
the grinding wheel is moved at a constant speed in the shift direction by the second mover while moving the grinding wheel in the tooth width direction by the first mover.

8. A gear grinding method of grinding a workpiece serving as a gear, the gear grinding method comprising:
grinding a workpiece by rotating a workpiece including a plurality of teeth on an outer peripheral surface thereof about a workpiece axis that is a central axis thereof;
meshing a grinding wheel including threads on an outer peripheral surface thereof with the workpiece while rotating the grinding wheel about a grinding wheel axis which is a central axis thereof; and
moving the grinding wheel from one end to another end of the workpiece in a tooth width direction parallel or substantially parallel to the workpiece axis (X1); wherein
the workpiece includes:
a first region located at a center portion in the tooth width direction; and
a second region closer to an end portion in the tooth width direction than the first region; and
a movement speed of the grinding wheel in the tooth width direction when grinding the first region is lower than a movement speed of the grinding wheel in the tooth width direction when grinding the second region.

9. The gear grinding method according to claim 8, wherein a movement speed of the grinding wheel in the tooth width direction is gradually changed between the first region and the second region.

10. The gear grinding method according to claim 9, wherein a movement speed of the grinding wheel in the tooth width direction is changed in a sinusoidal shape.

11. The gear grinding method according to claim 8, wherein a maximum value of a movement speed of the grinding wheel in the tooth width direction is more than 1 time and 20 times or less a minimum value of a movement speed of the grinding wheel in the tooth width direction.

12. The gear grinding method according to claim 11, wherein a movement speed of the grinding wheel in the tooth width direction becomes the minimum value only once while the grinding wheel moves once from one end to another end of the workpiece in the tooth width direction.

13. The gear grinding method according to claim 8, wherein a movement speed of the grinding wheel in the tooth width direction is calculated based on a change rate of a movement speed of the grinding wheel in the tooth width direction and a movement time of the grinding wheel in the tooth width direction.

14. The gear grinding method according to claim 8, wherein, the grinding wheel is moved at a constant speed in a shift direction parallel or substantially parallel to the grinding wheel axis while the grinding wheel is moved in the tooth width direction.
